(19) United States
(12) Patent Application Publication
(10) Pub. No.: US 2005/0119400 A1
(43) Pub. Date: Jun. 2, 2005

(54) Adhesive additive for a water lacquer

(76) Inventors: Jurgen Ortmeier, Kircheim (DE); Ramona Baumgartel, Stuttgart (DE); Tanja Muller, Korntal-Munchingen (DE)

Correspondence Address: NATH & ASSOCIATES, 1030 15th STREET, NW, 6TH FLOOR, WASHINGTON, DC, 20005, US

(21) Appl. No.: 10/514,049

(22) PCT Filed: Aug. 21, 2003
(86) PCT No.: PCT/EP03/09255

(30) Foreign Application Priority Data
Aug. 29, 2002 (DE) 102407339

(51) Int. Cl. C08L 1/00

(52) U.S. Cl. 524/543

(57) ABSTRACT

Adhesion additive for an aqueous paint, which comprises at least one binder and/or at least one pigment and/or filler and also at least one halogenated polyolefin (HPO), water, up to 25% by weight of solvents and, if desired, additives customary for aqueous paints. By virtue of the adhesion additive it is possible to apply paint coatings directly to plastic substrates without a primer.

The invention relates to an adhesion additive for an aqueous paint, to a curative for an aqueous paint, to the use of the adhesion additive for preparing an aqueous paint, to the use of the curative for preparing an aqueous paint, to an aqueous paint which comprises the adhesion additive and/or the curative, to the use of the aqueous paint for painting plastic substrates and to a plastic part having a paint coating.

In industry today the use of plastic moldings which possess a paint coating is on the increase. This relates in particular to plastic parts on motor vehicles, such as bumpers, protection strips, spoilers, wheel arch linings and side sills. These parts are increasingly being manufactured from plastics with a polypropylene (PP) fraction of up to 100%. The plastic parts which are used together with metal parts, especially in the automobile industry, frequently receive a paint coating in the same color as that possessed by the other metal parts.

At the present time these plastic moldings are first provided with a primer and are then painted first with a basecoat in the desired color and subsequently with a clearcoat. Both solventborne and aqueous paints are available for these purposes. In order to reduce the painting operation by the additional workstep of priming, special formulas have been developed for solventborne paints (EP 455 211), which allow adhesion of the paint directly to the plastic surface without an additional primer coat. To date, however, it has not been possible to use water-based paints (WBP), which in view of the lower solvent fraction of not more than 25% are preferable to the conventional solventborne paints from environmental, safety and health standpoints, for direct painting of plastic parts having a PP fraction of up to 100%.

It is an object of the present invention, accordingly, to provide an aqueous paint which allows the direct painting of plastic moldings, in particular with a polypropylene fraction of up to 100%, and at the same time possesses good adhesion to the plastic substrate, preferably corresponding to that of a paint coating with priming beforehand. The paint coating ought in particular to produce the desired shade.

This object is achieved by means of an adhesion additive for an aqueous paint, comprising a binder and/or a pigment and/or a filler, and also halogenated polyolefins (HPO), water and solvents, and also additives customary for aqueous paints, in accordance with independent claim 1.

A further achievement consists in the provision of a curative for an aqueous paint in accordance with independent claim 13.

The object is likewise achieved by, an aqueous paint in accordance with independent claim 15 and also by an aqueous paint in accordance with independent claim 17.

Advantageous developments are specified in the dependent claims. The wording of all the claims is made by reference to the content of the description.

The adhesion additive of the invention for an aqueous paint contains 0.1% to 40% by weight of at least one binder (calculated as solids) and/or 0.1% to 45% by weight of at least one pigment and/or filler and also 0.5% to 30% by weight of at least one halogenated polyolefin (HPO), calculated as solids, and 0% to 80% by weight of water, 0% to 25% by weight of solvents, and, if desired, further additives customary for aqueous paints. The percentages indicated above, inclusive of the additives, add up in total to 100% by weight.

The pigments and/or fillers are generally solids. Accordingly the fraction of pigments and/or fillers refers to the fraction calculated as solids.

The advantages of the invention are among others that by adding the adhesion additive conventional aqueous; paints can be used directly, as the first coat, for painting plastic surfaces. As a result there is no need for an additional workstep in painting, i.e., priming, in the case of plastic substrates, which are very widespread particularly in the automobile industry. Moreover, the invention allows wet-on-wet painting. This results in substantial savings in terms of time expended, materials expended and costs.

With conventional aqueous paints it is necessary to carry out a priming step and possibly an intermediate sanding, as a result of which, in painting operations, there is a time-consuming workstep which must generally be carried out manually. The use of the aqueous paint of the invention as a refinish paint makes it possible, to do away with the priming and intermediate sanding of the surface to be painted.

In one embodiment of the invention the fraction of the binder (calculated as solids) is, advantageously 1% to 30% by weight, preferably 8% to 20% by weight and in particular 10% to 12% by weight.

The binder of the adhesion additive of the invention may be :a binder based on acrylic resins, melamine resins and/or polyurethanes. In one preferred embodiment the binder is a polyurethane resin.

The fraction of pigment and/or filler can in one embodiment be 0.1% to 30% by weight, preferably 5% to 20% by weight, in particular 13% to 17% by weight.

In one particular embodiment of the invention the pigment is a conductive pigment.

The halogenated polyolefin (HPO) according to one preferred embodiment is a chlorinated polyolefin (CPO). It is, however, also possible to use other halogenated polyolefins, especially fluorinated polyolefins (FPO) or brominated polyolefins (BPO). In one particularly preferred embodiment the chlorinated polyolefin is a chlorinated polypropylene. It is also conceivable to use other chlorinated polyolefins.

According to one embodiment the fraction (calculated as solids) of the chlorinated polyolefins a (CPO) is advantageously 1% to 20% by weight, preferably 3% to 10% by weight, in particular 6% to 8% by weight and with particular preference about 7% by weight.

In one advantageous version the chlorinated polyolefin is a polyolefin having a chlorine content of 0.5% to 45% by weight, preferably 5% to 30% by weight, more preferably 10% to 20% by weight and in particular about 16% by weight, based on the solids content of the chlorinated polyolefins.

The molecular weight of the chlorinated polyolefins (CPO) is preferably 5,000 to 200,000 g/mol, preferably 10,000 to 170,000 g/mol, in particular 20,000 to 100,000 g/mol, with particular preference 30,000 to 60,000 g/mol.

The fraction of water in the adhesion additive of the invention is advantageously 20% to 80% by weight, preferably 40% to 70% by weight, in particular about 60% by weight.

The adhesion additive of the invention may also include a fraction of solvents. By solvents are meant here, in the context of the present invention, organic solvents. Advantageously the fraction of solvents is 1% to 20% by weight; preferably 2% to 10% by weight and in particular about 5% by weight. In one embodiment the solvents are glycol ethers and white spirit.

Since the CPO is frequently soluble only in organic solvents, the solvent of the CPO is in particular, preferably, xylene, toluene and/or petroleum fractions, especially xylene. In further embodiments mixtures of solvents are also conceivable. It is also possible to use a mixture of solvent and water. In one preferred embodiment the CPO is soluble in water.

A further aspect of the invention embraces a curative for an aqueous paint which comprises at least one halogenated polyolefin, (HPO). The halogenated polyolefin (HPO) is preferably a chlorinated polyolefin having a chlorine content of 0.5% to 45% by weight, preferably 5% to 30% by weight, more preferably 10% to 20% by weight and in particular about 16%, based on the solids content of the chlorinated polyolefins. The molecular weight of the chlorinated polyolefin in the curative is preferably 5,000 to 200,000 g/mol, more preferably 10,000 to 170,000 g/mol, in particular 20,000 to 100,000 g/mol, with particular preference 30,000 to 60,000 g/mol. The chlorinated polyolefin according, to one preferred embodiment can be a chlorinated polypropylene. It is conceivable, however, to use other chlorinated polyolefins as well.

The invention further comprises an aqueous paint which comprises at least one basecoat customary for aqueous paints and also at least one adhesion additive of the invention. The weight ratio of adhesion additive to basecoat in the aqueous paint of the invention is 5:95 to 95:5. Preferably the weight ratio is between 30:70 to 50:50. In one preferred embodiment the weight ratio of adhesion additive to basecoat is 50:50. In one particularly preferred embodiment the, weight ratio of adhesion additive to basecoat is 30:70.

According to one embodiment the aqueous paint of the invention is a one-component paint. It is also possible for it to be a two-component-paint. A two-component paint for the purposes of the invention comprises a curative as well as the aqueous paint of the invention. The curative can be a commonly used curative and/or a curative which comprises an HPO.

The amount of the curative is advantageously 0.5%.to 25% by weight, preferably 1% to 15% by weight, in particular about 5% by weight. In one particular embodiment the weight ratio of adhesion additive to basecoat to curative is 50:50:5. In another embodiment the weight ratio of adhesion additive to basecoat to curative is 30:70:5.

The invention further embraces the use of the adhesion additive of the invention for preparing an aqueous paint, in particular an aqueous paint intended for painting plastic substrates.

The invention further embraces the use of the curative of the invention for preparing an aqueous paint, in particular an aqueous paint intended for painting plastic substrates.

The invention further embraces the use of the aqueous paint of the invention for painting plastic substrates, especially for painting motor vehicle parts.

The plastic substrates are preferably parts which contain a polypropylene fraction of up to 100% by weight. It is also conceivable, however, for the plastic substrates to be composed of at least one other material, preferably a polymeric material.

Advantageously the plastic substrates for painting are flamed on the surface by means of a flame, preferably a gas flame, immediately before the aqueous paint coat is applied. This removes impurities on the surface of the substrate, especially release agent residues, and, particularly through the introduction of polar groups, allows the aqueous paint to adhere to the plastic surface, especially the polypropylene surface. The flame is in particular a blue oxidizing flame.

It is also conceivable for the plastic substrates to be cleaned prior to flaming with a degreasing agent to remove fatty residues on the surface, before the aqueous paint of the invention is applied.

Application of the aqueous paint to the plastic substrate may take place for example by means of painting guns.

The invention further embraces a plastic part with a paint coating which comprises at least one adhesion additive of the invention.

In the text below the adhesion additive of the invention and also the aqueous paint according to the present invention are illustrated by means of detailed description of particular embodiments and also through examples. In these examples, individual features of the invention may be actualized alone or in combination with other features. The examples described serve merely for elucidation and for better understanding of the invention and should not be understood in any way whatsoever to be restrictive.

### EXAMPLES

a) Preparation of an adhesion additive (the percentages below relate in each case to % by weight of the commercial forms of the raw materials employed):

First of all 15% of a binder in the form of a polyurethane resin. (Daotan, 32% in water, VTW 1237, Solutia GmbH & Co. KG) are charged to a mixer. Subsequently the following raw materials are added individually, slowly, with stirring using a toothed disk; in the course of the addition the temperature ought not to exceed 40° C.: 0.4% of a dispersing assistant (Amp-90, Angus-Chemie GmbH), 2% of demineralized water (Herkommer and Bangerter GmbH & Co.), 1% white spirit (Testbenzin 145/200, Brenntag Chemiepartner GmbH), 0.5% of defoamer (Addcitol VXW 4973, Solutia GmbH & Co. KG), 0.3% of dispersant: (Orotan 731-K 25%, Rohm & Haas Deutschland GmbH) and 4% of an antisettling agent (BENTONE EW, Rheox, Inc. USA). This mixture is stirred for about 5 minutes.

Then the following fillers/pigments are added individually, slowly, with stirring using a toothed disk: 4.5% of pigment (LUZENAC 10M2 talc, Luzenac Deutschland GmbH), 5% of filler (Blanc-Fix-Micro, Sachtleben Chemie GmbH), 5% of a further filler (Omya BLS, Omya GmbH) and 0.5% of an antisettling agent (Aerosil R 972, Degussa AG). The overall mixture is stirred for about 5 minutes, in the course of which the temperature ought not to exceed 40° C. Subsequently the mixture is finely ground in a bead mill (particle size <20 μm). During the grinding operation as well the temperature ought not to exceed 40° C. The fine-ground mixture is removed from the bead mill, which is rinsed with 2% of demineralized water, which is added to the mixture.

Thereafter the following raw materials are added individually, slowly, with stirring using a toothed disk: 19.5% of binder (Daotan VTW 1237, 32% in water, Solutia GmbH & Co. KG), 35% of a chlorinated polyolefin (Hardlen EH 202, 20% in water, Siber Regner GmbH), 1% of demineralized water, 0.3% of a surface wetting agent (Troysol LAC, Troy Chemical Corporation), 1% of a glycol ether (butyldiglycol, Brenntag Chemiepartner GmbH), 1% of a further glycol ether (DOVANOL DPnB, dipropylene glycol n-butyl ether, Dow Chemical Company), 0.5% of white spirit (Testbenzin 145/200, Brenntag Chemiepartner GmbH) and 0.5% of a defoamer (Additol VXW 4973). The mixture is stirred for about 5 minutes.

Following this the viscosity is adjusted with 1% of thickener (VISCALEX HV 30, Ciba Spezialitätenchemie). The finished mixture is stirred for a further 15 minutes.

b) Preparation of the aqueous paint:

One-component aqueous paint: 50 parts by weight of the water-based paint (Wörwag 104131) are introduced and 50 parts by weight of the adhesion additive are added slowly with stirring using a toothless stirring disk, followed by stirring for a further 5 minutes.

Two-component aqueous paint: First of all 50 parts by weight of the water-based paint (Wörwag 104131) are introduced and mixed thoroughly. Then, slowly, 50 parts by weight of adhesion additive are added with stirring using a toothless stirring disk, followed by stirring for a further 5 minutes. A further 5 parts by weight of a curative (Desmodur N 3368 SN, Bayer AG) are added to this mixture, giving an overall weight ratio of 50:50:5 (basecoat:adhesion additive:curative)

c) Adhesion test:

The plastic substrate of polypropylene is first cleaned with a degreasing agent and then flamed with a manual flaming device having a blue oxidizing flame. Subsequently the one-component paint is applied using a painting gun to the polypropylene plastic surface. The paint is dried by flashing off at room temperature for about 5 minutes and then a second paint coat, consisting of the water-based paint without adhesion additive, is applied wet on wet, flashed off at room temperature for about 10 minutes and then dried at 80° C. for about 10 minutes. As the final paint coat a clearcoat is applied, which is dried initially at room temperature for about 10 minutes and then at 80° C. for about 45 minutes.

With the painted surface a cross-cut test is carried out in accordance with the standard EN ISO 2409.

Table 1 shows the results of the cross-cut test on a one-component (1 K) paint and on a two-component (2 K) paint on a flamed and also an unflamed 100% polypropylene plastic surface, using as example two aqueous paints with a mixing ratio of adhesion additive to water-based paint of 50:50 and 30:70. respectively. The results without, adhesion additive are also indicated as a reference.

1-26. (canceled)

27. An adhesion additive for an aqueous paint, containing
0.1% to 40% by weight of at least one binder calculated as solids and/or
0.1% to 45% by weight of at least one pigment and/or filler and
0.5% to 30% by weight of at least one halogenated polyolefin (HPO) calculated as solids and
0% to 80% by weight of water, and
0% to 25% by weight of solvents, and
optionally, further additives customary for aqueous paints;
wherein the above-mentioned percentages by weight inclusive of the additives adding up to 100% weight.

28. The adhesion additive of claim 27, characterized in that calculated as solids there are 5% to 30% by weight, preferably 8% to 20% by weight, in particular 10% to 12% by weight of binder(s).

29. The adhesion additive of claim 27, characterized in that binders based on acrylic resins, melamine resins and/or polyurethanes are present.

30. The adhesion additive of claim 27, characterized in that 0.1% to 30% by weight, preferably 5% to 20% by weight, in particular 13% to 17% by weight of pigments and/or fillers are present.

31. The adhesion additive of claim 27, characterized in that the pigment is a conductive pigment.

32. The adhesion additive of claim 27, characterized in that the halogenated polyolefin is a chlorinated polyolefin (CPO), preferably a chlorinated polypropylene.

33. The adhesion additive of claim 32, characterized in that calculated as solids the fraction of chlorinated polyolefins (CPO) is 1% to 20% by weight, preferably 3% to 10% by weight.

34. The adhesion additive of claim 32, characterized in that calculated as solids the fraction of chlorinated polyolefins is preferably 6% to 8% by weight, in particular about 7% by weight.

35. The adhesion additive of claim 32, characterized in that the chlorinated polyolefin is a polyolefin having a chlorine content of 0.5% to 45% by weight, preferably 5% to 30% by weight, more preferably 10% to 20% by weight and in particular about 16% by weight, based on the solids content of the chlorinated polyolefins.

36. The adhesion additive of claim 32, characterized in that the chlorinated polyolefin is a polyolefin having a molecular weight of 5,000 to 200,000 g/mol, preferably 10,000 to 170,000 g/mol, in particular 20,000 to 100,000 g/mol and with particular preference 30,000 to 60,000 g/mol.

37. The adhesion additive of claim 27, characterized in that 20% to 80% by weight, preferably 40% to 70% by weight, in particular about 60% by weight of water is present.

38. The adhesion additive of claim 27, characterized in that 1% to 20% by weight, preferably 2% to 10% by weight, in particular about 5% by weight of solvent is present.

39. A curative for an aqueous paint, which comprises at least one halogenated polyolefin (HPO).

40. The curative of claim 39, wherein the HPO is a chlorinated polypropylene (CPO), preferably a chlorinated polypropylene.

41. An aqueous paint comprising at least one basecoat customary for aqueous paints and at least one adhesion additive of any one of the preceding claims, the weight ratio of adhesion additive to basecoat being between 5:95 and 95:5.

42. The aqueous paint of claim 41, characterized in that the weight ratio of adhesion additive to basecoat is preferably between 30:70 and 50:50.

43. An aqueous paint comprising a curative of claim 39.

44. The aqueous paint of claim 41, characterized in that it is a one-component paint.

45. The aqueous paint of claim 41 characterized in that it is a two-component paint which comprises a curative.

46. The aqueous paint of claim 45, characterized in that the amount of the curative is 0.5% to 25% by weight, preferably 1% to 15% by weight, in particular about 5% by weight.

47. A plastic part with a paint coating, characterized in that the paint coating comprises at least one adhesion additive of claim 27.
